(19) United States
(12) Patent Application Publication
(10) Pub. No.: US 2025/0080045 A1
(43) Pub. Date: Mar. 6, 2025

(54) PHOTOVOLTAIC SHINGLES WITH MULTI-MODULE POWER ELECTRONICS

(71) Applicant: GAF Energy LLC, Parsippany, NJ (US)

(72) Inventors: Richard Perkins, San Jose, CA (US); Gabriela Bunea, San Jose, CA (US); Thierry Nguyen, San Francisco, CA (US); Lewis Abra, San Francisco, CA (US); Babak Farhangi, San Jose, CA (US); Hasib Amin, Parsippany, NJ (US); Henry Pham, San Jose, CA (US)

(21) Appl. No.: 18/949,344

(22) Filed: Nov. 15, 2024

Related U.S. Application Data
(63) Continuation of application No. 18/584,881, filed on Feb. 22, 2024, now Pat. No. 12,176,849.
(60) Provisional application No. 63/486,574, filed on Feb. 23, 2023.

(51) Int. Cl. H02S 40/36; E04D 1/30; H02S 20/25

(52) U.S. Cl. CPC H02S 40/36; E04D 1/30; H02S 20/25; E04D 2001/308

(57) ABSTRACT

A system includes a plurality of building integrated photovoltaic modules installed on a roof deck and arranged in an array. The plurality of building integrated photovoltaic modules includes a first building integrated photovoltaic module and a second building integrated photovoltaic module, with the first building integrated photovoltaic module being vertically adjacent to the second building integrated photovoltaic module. Each of the building integrated photovoltaic modules includes a plurality of solar cells arranged in at least one row, and a power electronics unit. The power electronics unit is adjacent to a first end of one of the at least one row of the plurality of solar cells. The power electronics unit is electrically connected to the plurality of solar cells. The power electronics unit of the first building integrated photovoltaic module is electrically connected to the power electronics unit of the second building integrated photovoltaic module.

### CROSS-REFERENCE TO RELATED APPLICATION

This application is a continuation of U.S. Non-Provisional patent application Ser. No. 18/584,881, filed Feb. 22, 2024, which is a Section 111(a) application relating to and claiming the benefit of commonly owned, U.S. Provisional Patent Application Ser. No. 63/486,574, filed Feb. 23, 2023, entitled “PHOTOVOLTAIC SHINGLES WITH MULTI-MODULE POWER ELECTRONICS,” the contents of each of which are incorporated herein by reference in its entirety.

### FIELD OF THE INVENTION

The present invention relates to photovoltaic shingles and, more particularly, photovoltaic shingles with multi-module power electronics.

### BACKGROUND

Photovoltaic systems are installed on building roofs to generate electricity.

### SUMMARY

In some embodiments, a system includes a plurality of building integrated photovoltaic modules installed on a roof deck, wherein the plurality of building integrated photovoltaic modules is arranged in an array on the roof deck, wherein the plurality of building integrated photovoltaic modules includes a first building integrated photovoltaic module and a second building integrated photovoltaic module, wherein the first building integrated photovoltaic module is vertically adjacent to the second building integrated photovoltaic module, wherein each of the plurality of building integrated photovoltaic modules includes a plurality of solar cells arranged in at least one row, and a power electronics unit, wherein the power electronics unit is adjacent to a first end of one of the at least one row of the plurality of solar cells, wherein the power electronics unit is electrically connected to the plurality of solar cells, and wherein the power electronics unit of the first building integrated photovoltaic module is electrically connected to the power electronics unit of the second building integrated photovoltaic module.

In some embodiments, the power electronics unit is horizontally adjacent to the first end of the one of the at least one row of the plurality of solar cells. In some embodiments, the plurality of building integrated photovoltaic modules is a plurality of solar shingles. In some embodiments, the at least one row includes a plurality of rows, wherein the plurality of rows includes a first row and a second row above the first row, wherein each of the plurality of building integrated photovoltaic modules includes a first electrical connector proximate to the first end of the first row and electrically connected to the first row of the plurality of solar cells, and a second electrical connector proximate to a first end of the second row and electrically connected to the second row of the plurality of solar cells, and wherein the power electronics unit is connected to the first electrical connector and the second electrical connector.

In some embodiments, the power electronics unit includes a first terminal and a second terminal, wherein the first terminal of the power electronics unit of the first building integrated photovoltaic module is electrically connected to the second electrical connector of the first building integrated photovoltaic module, and wherein the first terminal of the power electronics unit of the second building integrated photovoltaic module is electrically connected to the second electrical connector of the second building integrated photovoltaic module. In some embodiments, each of the first electrical connector and the second electrical connector includes a first connector and a second connector, wherein the first terminal of the power electronics unit of the first building integrated photovoltaic module is electrically connected to the first connector of the second electrical connector of the first building integrated photovoltaic module, and wherein the first terminal of the power electronics unit of the second building integrated photovoltaic module is electrically connected to the first connector of the second electrical connector of the second building integrated photovoltaic module.

In some embodiments, the power electronics unit of the first building integrated photovoltaic module is mechanically connected to the second electrical connector of the first building integrated photovoltaic module, and wherein the power electronics unit of the second building integrated photovoltaic module is mechanically connected to the second electrical connector of the second building integrated photovoltaic module.

In some embodiments, the first terminal of the power electronics unit of the first building integrated photovoltaic module is mechanically connected to the first connector of the second electrical connector of the first building integrated photovoltaic module. In some embodiments, the first terminal of the power electronics unit of the second building integrated photovoltaic module is mechanically connected to the first connector of the second electrical connector of the second building integrated photovoltaic module. In some embodiments, the second terminal of the power electronics unit of the first building integrated photovoltaic module is electrically connected to the second connector of the first electrical connector of the first building integrated photovoltaic module by a first electrical cable. In some embodiments, the second connector of the second electrical connector of the first building integrated photovoltaic module is electrically connected to the first connector of the first electrical connector of the first building integrated photovoltaic module by a second electrical cable. In some embodiments, the second terminal of the power electronics unit of the second building integrated photovoltaic module is electrically connected to the second connector of the first electrical connector of the second building integrated photovoltaic module by a third electrical cable. In some embodiments, the second connector of the second electrical connector of the second building integrated photovoltaic module is electrically connected to the first connector of the first electrical connector of the second building integrated photovoltaic module by a fourth electrical cable. In some embodiments, the power electronics unit includes a third terminal and a fourth terminal, wherein the third terminal of the power electronics unit of the first building integrated photovoltaic module is electrically connected to the fourth terminal of the power electronics unit of the second building integrated photovoltaic module by a fifth electrical cable.

In some embodiments, the system further includes a third electrical connector installed on the roof deck, wherein each of the power electronics unit of the first building integrated photovoltaic module and the power electronics unit of the second building integrated photovoltaic module is electrically connected to the third electrical connector. In some embodiments, the third electrical connector includes a first connector and a second connector, wherein the third terminal of the power electronics unit of the second building integrated photovoltaic module is electrically connected to the first connector of the third electrical connector by a sixth electrical cable. In some embodiments, the fourth terminal of the power electronics unit of the first building integrated photovoltaic module is electrically connected to the second connector of the third electrical connector by a seventh electrical cable.

In some embodiments, the power electronics unit includes a housing and power electronics within the housing. In some embodiments, the power electronics includes an optimizer, a bypass diode, system monitoring electronic components, a rapid shutdown device, an electronic communication component, or combinations thereof.

In some embodiments, each of the plurality of rows includes a second end opposite the first end of the row, wherein each of the first building integrated photovoltaic module and the second building integrated photovoltaic module includes a first negative electrical terminal located at the first end of the first row thereof, a first positive electrical terminal located at the second end of the second row thereof, a second positive electrical terminal located at the first end of the second row thereof, and a second negative terminal located at the second end of the second row thereof.

In some embodiments, the plurality of building integrated photovoltaic modules is installed on the roof deck by a plurality of fasteners. In some embodiments, the plurality of building integrated photovoltaic modules includes a third building integrated photovoltaic module, wherein the third building integrated photovoltaic module is horizontally adjacent to the first building integrated photovoltaic module. In some embodiments, the plurality of building integrated photovoltaic modules includes a fourth building integrated photovoltaic module, wherein the fourth building integrated photovoltaic module is horizontally adjacent to the second building integrated photovoltaic module. In some embodiments, the fourth building integrated photovoltaic module is vertically adjacent to the third building integrated photovoltaic module. In some embodiments, the power electronics unit of the third building integrated photovoltaic module is electrically connected to the power electronics unit of the fourth building integrated photovoltaic module.

In some embodiments, a system includes a plurality of building integrated photovoltaic modules installed on a roof deck, wherein the plurality of building integrated photovoltaic modules is arranged in an array on the roof deck, wherein the plurality of building integrated photovoltaic modules includes a first building integrated photovoltaic module and a second building integrated photovoltaic module, wherein the first building integrated photovoltaic module is vertically adjacent to the second building integrated photovoltaic module, wherein each of the plurality of building integrated photovoltaic modules includes a plurality of solar cells arranged in at least one row; a first power electronics unit, wherein the first power electronics unit is adjacent to a first end of one of the at least one row of the plurality of solar cells of the first building integrated photovoltaic module, wherein the first power electronics unit is electrically connected to the plurality of solar cells of the first building integrated photovoltaic module; and a second power electronics unit, wherein the second power electronics unit is adjacent to a first end of one of the at least one row of the plurality of solar cells of the second building integrated photovoltaic module, and wherein the first power electronics unit is electrically connected to the second power electronics unit.

In some embodiments, a method includes obtaining a plurality of building integrated photovoltaic modules, wherein each of the plurality of building integrated photovoltaic modules includes a plurality of solar cells arranged in at least one row, and a power electronics unit, wherein the power electronics unit is adjacent to a first end of one of the at least one row of the plurality of solar cells, wherein the power electronics unit is electrically connected to the plurality of solar cells; and installing at least a first building integrated photovoltaic module and a second building integrated photovoltaic module on a roof deck, wherein the first building integrated photovoltaic module is vertically adjacent to the second building integrated photovoltaic module, and wherein the power electronics unit of the first building integrated photovoltaic module is electrically connected to the power electronics unit of the second building integrated photovoltaic module.

In some embodiments, the method further includes installing a third building integrated photovoltaic module and a fourth building integrated photovoltaic module on the roof deck, wherein the third building integrated photovoltaic module is horizontally adjacent to the first building integrated photovoltaic module, and wherein the fourth building integrated photovoltaic module is horizontally adjacent to the second building integrated photovoltaic module and vertically adjacent to the third building integrated photovoltaic module. In some embodiments, the plurality of building integrated photovoltaic modules is a plurality of solar shingles. In some embodiments, the plurality of building integrated photovoltaic modules is installed on the roof deck by a plurality of fasteners.

### BRIEF DESCRIPTION OF THE DRAWINGS

FIGS. 1A and 1B are a top plan view and a side elevational view, respectively, of some embodiments of a photovoltaic shingle;

FIG. 2 is a top plan view of some embodiments of a portion of a roofing system including photovoltaic shingles;

FIG. 3 illustrates some embodiments of a power electronics unit;

FIG. 4 is a top plan view of some embodiments of a portion of a roofing system including photovoltaic shingles and power electronics units;

FIGS. 4A through 4C are schematic views of some embodiments of power electronics for photovoltaic shingles;

FIG. 5 is a top plan view of some embodiments of a photovoltaic module;

FIG. 6 is a top plan view of some embodiments of a photovoltaic shingle including photovoltaic modules shown in FIG. 5;

FIG. 7 is a top plan view of some embodiments of a photovoltaic module;

FIG. 8 is a top plan view of some embodiments of a roofing system including photovoltaic shingles having the photovoltaic modules shown in FIG. 7; and

FIGS. 9 through 11 are schematic, top plan views of some embodiments of photovoltaic shingles.

### DETAILED DESCRIPTION

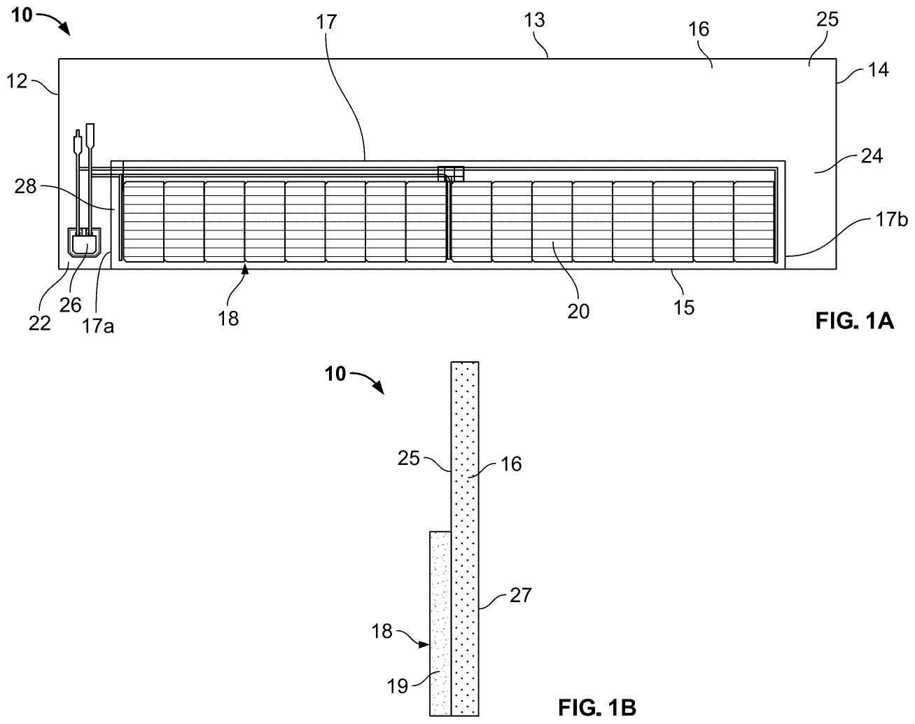

Referring to FIGS. 1A and 1B, in some embodiments, a photovoltaic shingle 10 includes a first end 12, a second end 14 opposite the first end 12, a first edge 13 extending from the first end 12 to the second end 14, and a second edge 15 opposite the first edge 13 and extending from the first end 12 to the second end 14. In some embodiments, the photovoltaic shingle 10 includes a headlap portion 16. In some embodiments, the headlap portion 16 extends from the first end 12 to the second end 14 and from the first edge 13 to a first location 17 between the first edge 13 and the second edge 15. In some embodiments, the photovoltaic shingle 10 includes a reveal portion 18. In some embodiments, the reveal portion 18 includes a photovoltaic layer 19. In some embodiments, the photovoltaic layer 19 includes at least one solar cell 20. In some embodiments, the photovoltaic shingle 10 includes a first side lap portion 22 located at the first end 12. In some embodiments, the first side lap portion 22 includes a width extending from the first end 12 to a second location 17a between the first end 12 and the second end 14. In some embodiments, the first side lap portion 22 includes a length extending from the first location 17 to the second edge 15. In some embodiments, the photovoltaic shingle 10 includes a second side lap portion 24 located at the second end 14. In some embodiments, the second side lap portion 24 includes a width extending from the second end 14 to a third location 17b between the first end 12 and the second end 14. In some embodiments, the second side lap portion 24 includes a length extending from the first location 17 to the second edge 15. In some embodiments, the photovoltaic shingle 10 includes an outer surface 25 and an inner surface 27 opposite the outer surface 25. In some embodiments, the reveal portion 18 extends from the first side lap portion 22 to the second side lap portion 24 and from the second edge 15 to the first location 17. In some embodiments, the photovoltaic shingle 10 is configured to be installed on a building structure. In some embodiments, the photovoltaic shingle 10 is configured to be installed on a roof deck. In some embodiments, at least one junction box 26 is located on the first side lap portion 22. In some embodiments, the at least one junction box 26 includes a plurality of the junction boxes 26. In certain embodiments, other electronic and electrical components may be attached to the first side lap portion 22. In some embodiments, non-limiting examples of such electronic and electrical components include an electrical connector, a rapid shutdown device, an optimizer, and an inverter. In some embodiments, the photovoltaic shingle 10 includes a structure, composition, components, and/or function similar to those of one or more embodiments of the photovoltaic shingles disclosed in in PCT International Patent Publication No. WO 2022/051593, Application No. PCT/US2021/049017, published Mar. 10, 2022, entitled “Building Integrated Photovoltaic System,” owned by GAF Energy LLC, and U.S. Pat. No. 11,251,744 to Bunea et al., issued Feb. 15, 2022, entitled “Photovoltaic Shingles and Methods of Installing Same,” the contents of each of which are incorporated by reference herein in their entirety.

In some embodiments, the at least one solar cell 20 includes a plurality of the solar cells 20. In some embodiments, the plurality of solar cells 20 includes two solar cells. In some embodiments, the plurality of solar cells 20 includes three solar cells. In some embodiments, the plurality of solar cells 20 includes four solar cells. In some embodiments, the plurality of solar cells 20 includes five solar cells. In some embodiments, the plurality of solar cells 20 includes six solar cells. In some embodiments, the plurality of solar cells 20 includes seven solar cells. In some embodiments, the plurality of solar cells 20 includes eight solar cells. In some embodiments, the plurality of solar cells 20 includes nine solar cells. In some embodiments, the plurality of solar cells 20 includes ten solar cells. In some embodiments, the plurality of solar cells 20 includes eleven solar cells. In some embodiments, the plurality of solar cells 20 includes twelve solar cells.

In some embodiments, the plurality of solar cells 20 includes thirteen solar cells. In some embodiments, the plurality of solar cells 20 includes fourteen solar cells. In some embodiments, the plurality of solar cells 20 includes fifteen solar cells. In some embodiments, the plurality of solar cells 20 includes sixteen solar cells. In some embodiments, the plurality of solar cells 20 includes more than sixteen solar cells.

In some embodiments, the plurality of solar cells 20 is arranged in one row (i.e., one reveal). In another embodiment, the plurality of solar cells 20 is arranged in two rows (i.e., two reveals). In another embodiment, the plurality of solar cells 20 is arranged in three rows (i.e., three reveals). In another embodiment, the plurality of solar cells 20 is arranged in four rows (i.e., four reveals). In another embodiment, the plurality of solar cells 20 is arranged in five rows (i.e., five reveals). In another embodiment, the plurality of solar cells 20 is arranged in six rows (i.e., six reveals). In other embodiments, the plurality of solar cells 20 is arranged in more than six rows. In some embodiments, each of the rows of the plurality of solar cells 20 includes a first end 28 located proximate to the first side lap portion 22.

In some embodiments, a roofing system includes a plurality of the photovoltaic shingles 10 installed on a roof deck. In some embodiments, the roof deck is a steep slope roof deck. As defined herein, a “steep slope roof deck” is any roof deck that is disposed on a roof having a pitch of Y/X, where Y and X are in a ratio of 4:12 to 12:18, where Y corresponds to the “rise” of the roof, and where X corresponds to the “run” of the roof.

In some embodiments, the plurality of photovoltaic shingles 10 is installed directly to the roof deck. In some embodiments, each of the plurality of photovoltaic shingles 10 is installed on the roof deck by a plurality of fasteners. In some embodiments, the plurality of fasteners is installed through the headlap portion 16. In some embodiments, the plurality of fasteners includes a plurality of nails. In some embodiments, the plurality of fasteners includes a plurality of rivets. In some embodiments, the plurality of fasteners includes a plurality of screws. In some embodiments, the plurality of fasteners includes a plurality of staples.

In some embodiments, each of the plurality of photovoltaic shingles 10 is installed on the roof deck by an adhesive. In some embodiments, the adhesive is adhered directly to the roof deck. In some embodiments, the adhesive is adhered to an underlayment. In some embodiments, the underlayment is adhered directly to the roof deck. In some embodiments, the adhesive is located on a rear surface of the photovoltaic shingle 10. In some embodiments, the adhesive includes at least one adhesive strip. In some embodiments, the adhesive includes a plurality of adhesive strips. In some embodiments, the plurality of adhesive strips is arranged intermittently. In some embodiments, the adhesive is located proximate to one edge of the photovoltaic shingle 10. In some embodiments, the adhesive is a peel and stick film sheet. In some embodiments, the peel and stick film sheet includes at least one sheet of film removably attached to the rear surface. In some embodiments, the peel and stick film sheet is composed of EverGuard Freedom HW peel and stick membrane manufactured by GAF. In some embodiments, the adhesive includes polyvinyl butyrate, acrylic, silicone, or polycarbonate. In some embodiments, the adhesive includes pressure sensitive adhesives.

In some embodiments, a first photovoltaic shingle 10 is vertically adjacent to a second photovoltaic shingle 10. In some embodiments, the first photovoltaic shingle 10 overlays at least a part of the headlap portion 16 of the second photovoltaic shingle 10.

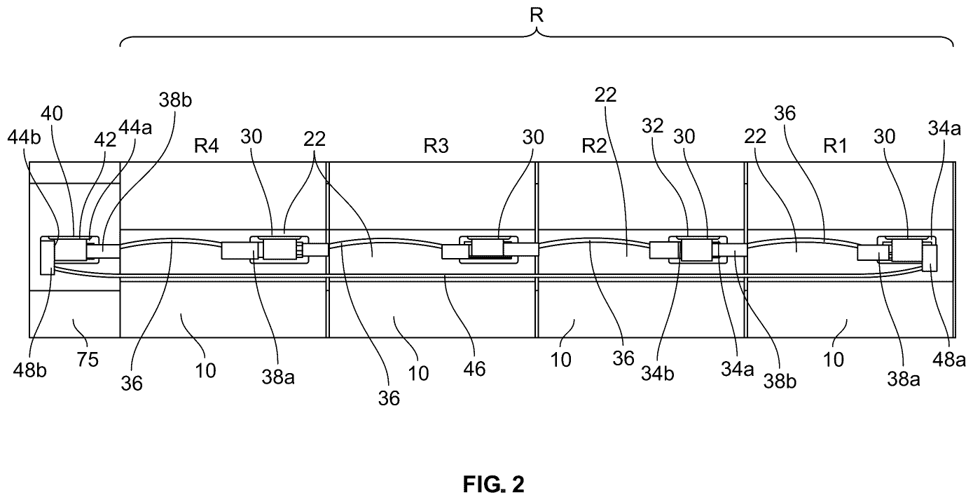

Referring to FIG. 2, in some embodiments, a roofing system includes a plurality of photovoltaic shingles 10 installed on a roof deck 75 in a plurality of rows R. In some embodiments, each of a plurality of the photovoltaic shingles 10 includes a first electrical connector 30. In some embodiments, the first electrical connector 30 is located on the first side lap portion 22. In some embodiments, the first electrical connector 30 is located on the first side lap portion 22 proximate to the first end 28 of the row of solar cells 20. In some embodiments, the first electrical connector 30 is at least partially embedded within the side lap portion 22. In some embodiments, the first electrical connector 30 is attached to an upper surface of the side lap portion 22. In some embodiments, the first electrical connector 30 is attached to the upper surface of the side lap portion 22 by an adhesive. In some embodiments, the first electrical connector 30 is attached to the upper surface of the side lap portion 22 by welding. In some embodiments, the first electrical connector 30 is attached to the upper surface of the side lap portion 22 by heat welding. In some embodiments, the first electrical connector 30 is attached to the upper surface of the side lap portion 22 by ultrasonic welding. In some embodiments, the first electrical connector 30 is attached to the upper surface of the side lap portion 22 by at least one fastener. In some embodiments, the first electrical connector 30 is removably attached to the upper surface of the side lap portion 22.

In some embodiments, the first electrical connector 30 includes a structure, composition, components, and/or function similar to those of one or more embodiments of the electrical connectors disclosed in U.S. Patent Application Publication No. 2022/0029037 to Nguyen et al., published Jan. 27, 2022 and entitled “Photovoltaic Systems” and U.S. Patent Application Publication No. 2022/0311377 to Bunea et al., published Sep. 29, 2022 and entitled

“Electrical Components for Photovoltaic Systems,” the contents of each of which are incorporated by reference herein in its entirety.

In some embodiments, the first electrical connector 30 has a thickness of 1 mm to 10 mm. In some embodiments, the first electrical connector 30 has a thickness of 1 mm to 9 mm. In some embodiments, the first electrical connector 30 has a thickness of 1 mm to 8 mm. In some embodiments, the first electrical connector 30 has a thickness of 1 mm to 7 mm. In some embodiments, the first electrical connector 30 has a thickness of 1 mm to 6 mm. In some embodiments, the first electrical connector 30 has a thickness of 1 mm to 5 mm. In some embodiments, the first electrical connector 30 has a thickness of 1 mm to 4 mm. In some embodiments, the first electrical connector 30 has a thickness of 1 mm to 3 mm. In some embodiments, the first electrical connector 30 has a thickness of 1 mm to 2 mm. In some embodiments, the first electrical connector 30 has a thickness of 2 mm to 10 mm. In some embodiments, the first electrical connector 30 has a thickness of 2 mm to 9 mm. In some embodiments, the first electrical connector 30 has a thickness of 2 mm to 8 mm. In some embodiments, the first electrical connector 30 has a thickness of 2 mm to 7 mm. In some embodiments, the first electrical connector 30 has a thickness of 2 mm to 6 mm. In some embodiments, the first electrical connector 30 has a thickness of 2 mm to 5 mm. In some embodiments, the first electrical connector 30 has a thickness of 2 mm to 4 mm. In some embodiments, the first electrical connector 30 has a thickness of 2 mm to 3 mm. In some embodiments, the first electrical connector 30 has a thickness of 3 mm to 10 mm. In some embodiments, the first electrical connector 30 has a thickness of 3 mm to 9 mm. In some embodiments, the first electrical connector 30 has a thickness of 3 mm to 8 mm. In some embodiments, the first electrical connector 30 has a thickness of 3 mm to 7 mm. In some embodiments, the first electrical connector 30 has a thickness of 3 mm to 6 mm. In some embodiments, the first electrical connector 30 has a thickness of 3 mm to 5 mm. In some embodiments, the first electrical connector 30 has a thickness of 3 mm to 4 mm. In some embodiments, the first electrical connector 30 has a thickness of 4 mm to 10 mm. In some embodiments, the first electrical connector 30 has a thickness of 4 mm to 9 mm. In some embodiments, the first electrical connector 30 has a thickness of 4 mm to 8 mm. In some embodiments, the first electrical connector 30 has a thickness of 4 mm to 7 mm. In some embodiments, the first electrical connector 30 has a thickness of 4 mm to 6 mm. In some embodiments, the first electrical connector 30 has a thickness of 4 mm to 5 mm. In some embodiments, the first electrical connector 30 has a thickness of 5 mm to 10 mm. In some embodiments, the first electrical connector 30 has a thickness of 5 mm to 9 mm. In some embodiments, the first electrical connector 30 has a thickness of 5 mm to 8 mm. In some embodiments, the first electrical connector 30 has a thickness of 5 mm to 7 mm. In some embodiments, the first electrical connector 30 has a thickness of 5 mm to 6 mm.

In some embodiments, the first electrical connector 30 has a thickness of 6 mm to 10 mm. In some embodiments, the first electrical connector 30 has a thickness of 6 mm to 9 mm. In some embodiments, the first electrical connector 30 has a thickness of 6 mm to 8 mm. In some embodiments, the first electrical connector 30 has a thickness of 6 mm to 7 mm. In some embodiments, the first electrical connector 30 has a thickness of 7 mm to 10 mm. In some embodiments, the first electrical connector 30 has a thickness of 7 mm to 9 mm. In some embodiments, the first electrical connector 30 has a thickness of 7 mm to 8 mm. In some embodiments, the first electrical connector 30 has a thickness of 8 mm to 10 mm. In some embodiments, the first electrical connector 30 has a thickness of 8 mm to 9 mm. In some embodiments, the first electrical connector 30 has a thickness of 9 mm to 10 mm. In some embodiments, the first electrical connector 30 has a thickness of 1 mm. In some embodiments, the first electrical connector 30 has a thickness of 2 mm. In some embodiments, the first electrical connector 30 has a thickness of 3 mm. In some embodiments, the first electrical connector 30 has a thickness of 4 mm. In some embodiments, the first electrical connector 30 has a thickness of 5 mm. In some embodiments, the first electrical connector 30 has a thickness of 6 mm. In some embodiments, the first electrical connector 30 has a thickness of 7 mm. In some embodiments, the first electrical connector 30 has a thickness of 8 mm. In some embodiments, the first electrical connector 30 has a thickness of 9 mm. In some embodiments, the first electrical connector 30 has a thickness of 10 mm.

In some embodiments, the first electrical connector 30 is electrically connected to the plurality of solar cells 20. In some embodiments, the first electrical connector 30 is electrically connected to the plurality of solar cells 20 by electrical bussing. In some embodiments, the electrical bussing is embedded within the photovoltaic shingle 10.

In some embodiments, the first electrical connector 30 includes a housing 32 and a pair of connectors 34a, 34b. In some embodiments, the connectors 34a, 34b extend from the housing 32. In some embodiments, the connectors 34a, 34b are snap-fit connectors. In some embodiments, the connector 34a is spaced apart from the connector 34b. In some embodiments, the connector 34a is located proximate to one end of the housing 32 and the connector 34b is located proximate to an opposite end of the housing 32. In some embodiments, each of the first electrical connectors 30 is electrically connected to one another by a plurality of electrical jumper wires 36 (also referred to as jumper wires, electrical jumper cables, or jumper cables). In some embodiments, the first electrical connectors 30 are electrically connected to one another in series by the plurality of jumper wires 36. In some embodiments, each of the jumper wires 36 includes a first connector 38a at a first end thereof and a second connector 38b at a second, opposite end thereof. In some embodiments, the first connector 38a of a corresponding one of the jumper wires 36 is connected to a corresponding one of the connector 34b of the housing 32 of the first electrical connector 30. In some embodiments, the first connector 38a of a corresponding one of the jumper wires 36 is preconnected to a corresponding one of the connector 34b of the housing 32 of the first electrical connector 30 of the photovoltaic shingle 10 prior to installation on the roof deck 75. In some embodiments, the second connector 38b of a corresponding one of the jumper wires 36 is connected to a corresponding one of the connector 34a of the housing 32 of the first electrical connector 30 of an adjacent lower one of the plurality of photovoltaic shingles 10 in rows R2, R3, R4.

In some embodiments, the system includes a second electrical connector 40. In some embodiments, the second electrical connector 40 is installed on the roof deck 75. In some embodiments, the second electrical connector 40 is located below row R4. In some embodiments, the second electrical connector 40 is proximate to row R4. In some embodiments, the second electrical connector 40 is adjacent row R4. In some embodiments, the second electrical connector 40 includes a housing 42 and a pair of connectors 44a, 44b. In some embodiments, the connectors 44a, 44b extend from the housing 42. In some embodiments, the second electrical connector 40 has a similar structure and/or function of those of the first electrical connector 30. In some embodiments, a return wire 46 electrically connects the first electrical connector 30 of the photovoltaic shingle 10 in the uppermost row R1 with the second electrical connector 40. In some embodiments, the return wire 46 includes a first connector 48a at a first end thereof and a second connector 48b at a second, opposite end thereof. In some embodiments, the connector 48a of the return wire 46 is connected to the connector 34a of the first electrical connector 30 of the photovoltaic shingle 10 in row R1. In some embodiments, the connector 48b of the return wire 46 is connected to the connector 44b of the second electrical connector 40. In some embodiments, the return wire 46 has a length. In some embodiments, the length of the return wire 46 may vary and be selected by an installer of the system, depending upon the number of rows R of the photovoltaic shingles 10 in the column of the array thereof.

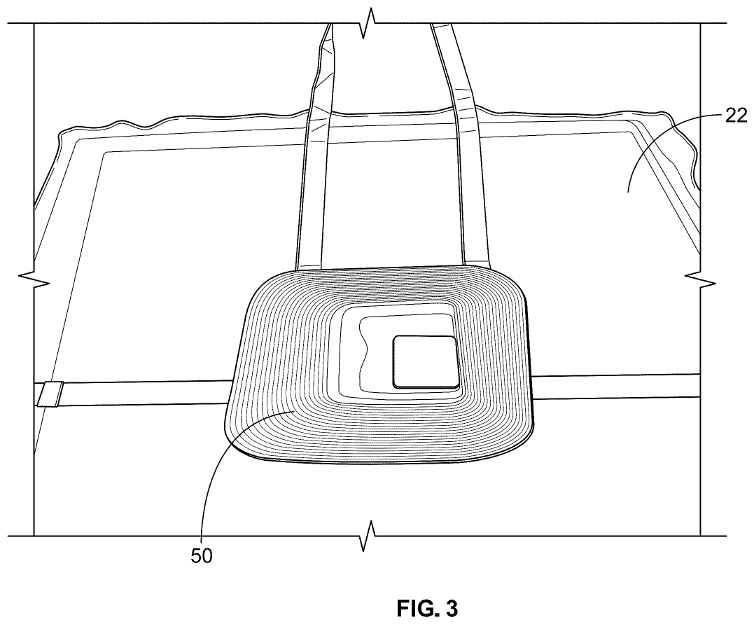

Referring to FIG. 3, in some embodiments, the photovoltaic shingle 10 includes a power electronics unit 50. In some embodiments, the power electronics unit 50 is located on the first side lap portion 22. In some embodiments, the power electronics unit 50 is attached to the first side lap portion 22. In some embodiments, the power electronics unit 50 is laminated with the first side lap portion 22. In some embodiments, the power electronics unit 50 is a DC optimizer PCB. In some embodiments, the power electronics unit 50 may be other PCB's having other functionality, such as bypass diodes, system monitoring electronic components, electronic communication components, rapid shutdown devices, or electronic circuitry assemblies performing one or more functionalities such as power optimization, rapid-shutdown, monitoring or communication.

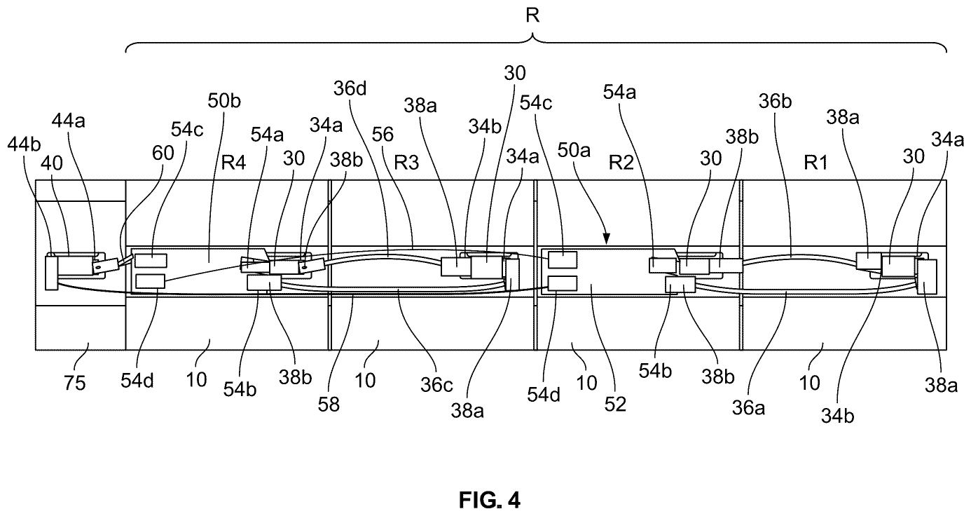

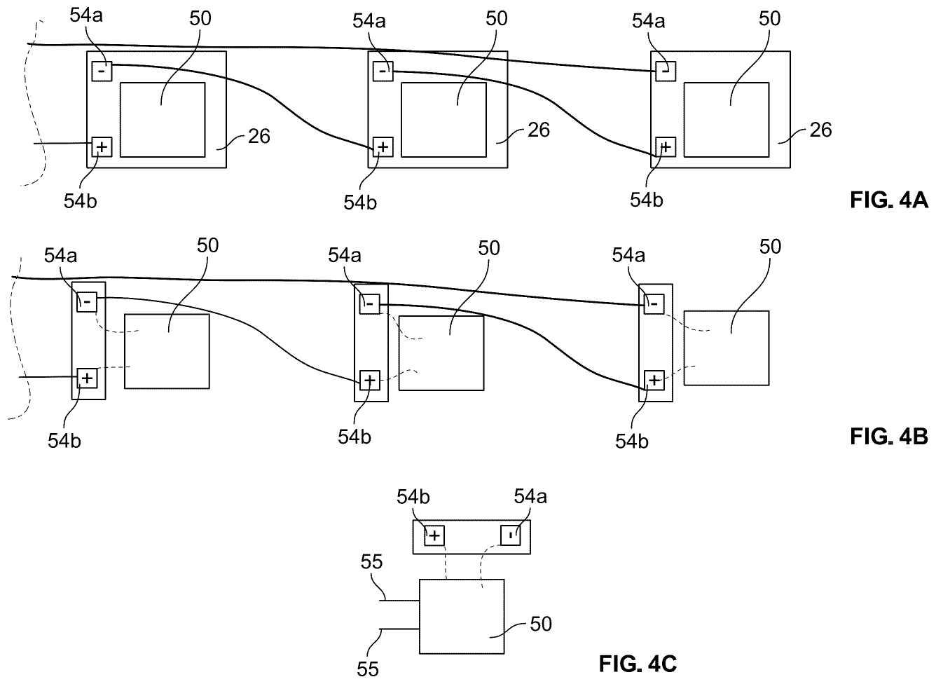

Referring to FIG. 4, in some embodiments, the roofing system illustrated in FIG. 3 and described above may be configured to incorporate a plurality of the power electronics units 50. In some embodiments, the power electronics units 50 are installed once every two rows of the photovoltaic shingles 10. In some embodiments, the power electronics units 50 are installed in every row of the photovoltaic shingles 10. In some embodiments, the power electronics units 50 are installed in some of the rows of the photovoltaic shingles 10. In some embodiments, the power electronics unit 50 includes a housing 52. In some embodiments, the housing 52 is composed of plastic. In some embodiments, the housing is composed of metal. In some embodiments, power electronics are sealed within the housing 52. In some embodiments, the power electronics unit 50 includes four terminals 54a, 54b, 54c, 54d. In some embodiments, each of the terminals 54a-d is a bulkhead terminal. In some embodiments, the power electronics unit 50 may include less than four of the terminals 54a-d. In some embodiments, the power electronics unit 50 may include more than four of the terminals 54a-d.

In some embodiments, a first power electronics unit 50a is installed on the photovoltaic shingle 10 in row R2. In some embodiments, the first power electronics unit 50a is connected to the first electrical connector 30 of the photovoltaic shingle 10 in row R2. In some embodiments, the terminal 54a of the first power electronics unit 50a is connected to connector 34a of the first electrical connector 30 of the photovoltaic shingle 10 in row R2. In some embodiments, the second connector 38b of jumper wire 36a is connected to the terminal 54b of the first power electronics unit 50a, while the first connector 38a of the jumper wire 36a is connected to the connector 34a of the first electrical connector 30 of the photovoltaic shingle 10 in row R1. In some embodiments, the second connector 38b of jumper wire 36b is connected to the first connector 34a of the connector 30 in row R2, while the first connector 38a of the jumper wire 36b is connected to the second connector 34b of the connector 30 in row R1.

In some embodiments, a second power electronics unit 50b is installed on the photovoltaic shingle 10 in row R4. In some embodiments, the second power electronics units 50b is connected to the first electrical connector 30 of the photovoltaic shingle 10 in row R4. In some embodiments, the terminal 54a of the second power electronics unit 50b is connected to connector 34a of the first electrical connector 30 of the photovoltaic shingle 10 in row R4. In some embodiments, the second connector 38b of jumper wire 36c is connected to the terminal 54b of the second power electronics unit 50b, while the first connector 38a of the jumper wire 36c is connected to the connector 34a of the first electrical connector 30 of the photovoltaic shingle 10 in row R3. In some embodiments, the second connector 38b of jumper wire 36d is connected to the first connector 34a of the connector 30 in row R4, while the first connector 38a of the jumper wire 36d is connected to the second connector 34b of the connector 30 in row R3.

In some embodiments, the terminal 54c of the first power electronics unit 50a is electrically connected to terminal 54d of the second power electronics unit 50b. In some embodiments, the terminal 54c of the first power electronics unit 50a is electrically connected to terminal 54d of the second power electronics unit 50b by a jumper wire 56. In some embodiments, the terminal 54d of the first power electronics unit 50a is electrically connected to the connector 44b of the second electrical connector 40. In some embodiments, the terminal 54d of the first power electronics unit 50a is electrically connected to the connector 44b of the second electrical connector 40 by a jumper wire 58. In some embodiments, the terminal 54c of the second power electronics unit 50b is electrically connected to the connector 44a of the second electrical connector 40. In some embodiments, the terminal 54c of the second power electronics unit 50b is electrically connected to the connector 44a of the second electrical connector 40 by a jumper wire 60. In some embodiments, the first power electronics unit 50a is electrically connected to the second power electronics unit 50b. In some embodiments, it should be understood that the roofing system may have more or less than four of the rows R1-R4 of the photovoltaic shingles 10, and, therefore, the configuration of the power electronics units 50a-b, the electrical connectors 30, 40 and wires 36a-d, 56, 58, 60 would be modified accordingly.

In some embodiments, any or all of the power electronics units 50a-b, the electrical connectors 30, 40 and wires 36a-d, 56, 58, 60 may be installed by an installer on the roof deck 75. In some embodiments, any or all of the power electronics units 50a-b, the electrical connectors 30, 40 and wires 36a-d, 56, 58, 60 may be prefabricated prior to installation by an installer on the roof deck 75. In some embodiments, at least two of the photovoltaic shingles 10 are mechanically attached to one another and to a common headlap portion using adhesives, bonding or thermal welding processes. In some embodiments, the power electronics units 50a-b and applicable ones of the wires 36a-d, 56, 58, 60 are attached to the photovoltaic shingles 10 that are on the common headlap portion.

Referring to FIG. 4A, in some embodiments, each of the power electronics units 50 is located within a corresponding one of the junction boxes 26. In some embodiments, the terminals 54a, 54b are located on or in the junction box 26. In some embodiments, at least one of the power electronics units 50 is located within a corresponding one of the junction boxes 26. Referring to FIG. 4B, in some embodiments, each of the power electronics units 50 is separate from the terminals 54a, 54b. Referring to FIG. 4C, in some embodiments, the power electronics unit 50 includes one or more electrical connections 55 to the photovoltaic module 10, the solar cells 20, circuit formation, or other circuitry in between.

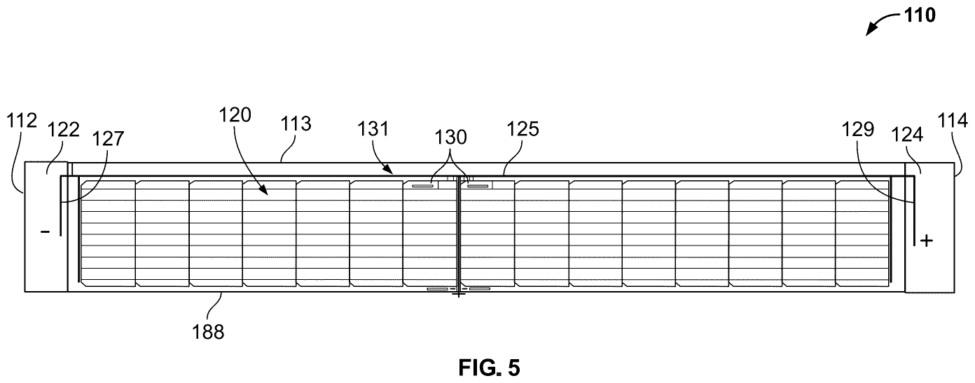

Referring to FIG. 5, in some embodiments, a photovoltaic module 110 includes a first end 112, a second end 114 opposite the first end 112, a reveal portion 118 having a plurality of solar cells 120, a first side lap portion 122 at the first end 112, and a second side lap portion 124 at the second end 114. In some embodiments, the photovoltaic module 110 includes a busbar 125 extending from the first side lap portion 122 to the second side lap portion 124. In some embodiments, the busbar 125 includes a first branch 127 located at the first side lap portion 122. In some embodiments, the busbar 125 includes a second branch 129 located at the second side lap portion 124. In some embodiments, the first branch 127 includes a negative electrical terminal. In some embodiments, the second branch 129 includes a positive electrical terminal. In some embodiments, the first branch 127 includes a positive electrical terminal. In some embodiments, the second branch 129 includes a negative electrical terminal. In some embodiments, the photovoltaic module 110 includes at least one bypass diode 130 electrically connected to the busbar 125. In some embodiments, the at least one bypass diode 130 includes a plurality of bypass diodes 130. In some embodiments, the at least one bypass diode 130 is located within a section 131 of the photovoltaic module 110 that is located between a first edge 113 of the photovoltaic module 110 and the plurality of solar cells 120.

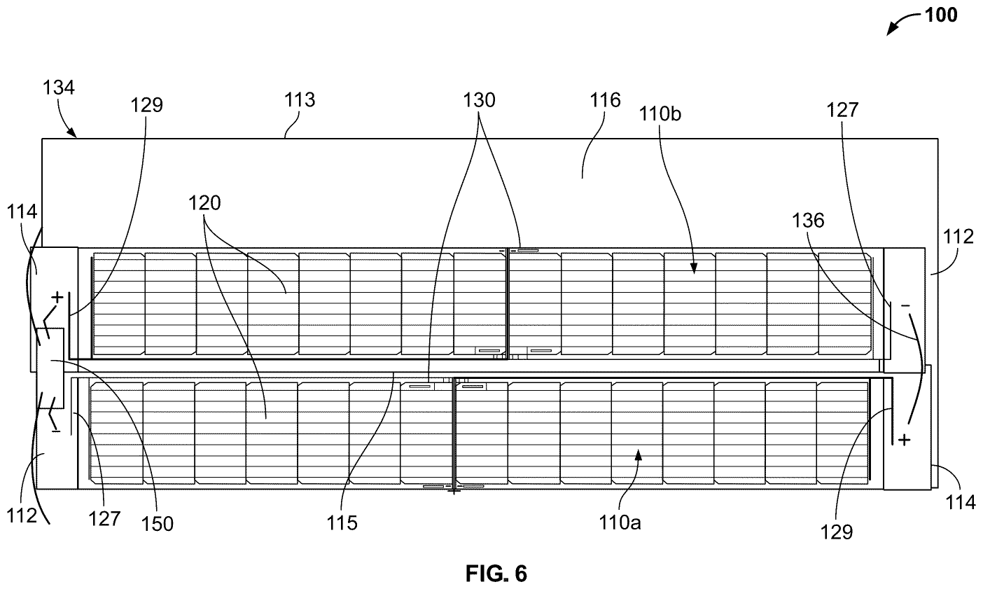

Referring to FIG. 6, in some embodiments, a photovoltaic shingle 100 includes a plurality of the photovoltaic modules 110. In some embodiments, the plurality of photovoltaic modules 110 is attached to a backsheet 134. In some embodiments, the plurality of photovoltaic modules 110 overlay the backsheet 134. In some embodiments each of the plurality of photovoltaic modules 110 is vertically stacked relative to one another on the backsheet 134. In some embodiments, the photovoltaic shingle 100 includes a headlap portion 116. In some embodiments, a portion of the backsheet 134 forms the headlap portion 116. In some embodiments, the backsheet 134 includes at least one layer. In some embodiments, the backsheet 134 includes at least two layers. In some embodiments, the backsheet 134 is composed of a polymeric material. In some embodiments, In some embodiments, the backsheet 134 is composed of polyethylene terephthalate (“PET”). In some embodiments, the backsheet 134 is composed of ethylene tetrafluoroethylene (“ETFE”). In some embodiments, the backsheet 134 is composed of an acrylic such as polymethyl methacrylate (“PMMA”). In some embodiments, the backsheet 134 is composed of thermoplastic polyolefin (TPO). In some embodiments, the backsheet 134 is composed of a single ply TPO roofing membrane. In some embodiments, non-limiting examples of TPO membranes are disclosed in U.S. Pat. No. 9,359,014 to Yang et al., which is incorporated by reference herein in its entirety. In some embodiments, the backsheet 134 is composed of polyvinyl chloride. In some embodiments, the backsheet 134 is composed of ethylene propylene diene monomer (EPDM) rubber. In some embodiments, the backsheet 134 includes a flame retardant additive. In some embodiments, the flame retardant additive may be clays, nanoclays, silicas, carbon black, metal hydroxides such as aluminum hydroxide, metal foils, graphite, and combinations thereof.

In some embodiments, the plurality of photovoltaic modules 110 is attached to the backsheet 134. In some embodiments, the plurality of photovoltaic modules 110 is attached to the backsheet 134 by an adhesive. In some embodiments, the plurality of photovoltaic modules 110 is attached to the backsheet 134 by thermal bonding. In some embodiments, the plurality of photovoltaic modules 110 is attached to the backsheet 134 by ultrasonic welding. In some embodiments, the plurality of photovoltaic modules 110 is attached to the backsheet 134 by thermal welding. In some embodiments, the plurality of photovoltaic modules 110 is attached to the backsheet 134 by mechanical fasteners. In some embodiments, the fasteners may include nails, screws, rivets, or staples.

Still referring to FIG. 6, in some embodiments, a first photovoltaic module 110a of the photovoltaic modules 110 is oriented such that it includes a negative terminal at the first end 112 and a positive terminal at the second end 114. In some embodiments, a second photovoltaic module 110b of the photovoltaic modules 110 is oriented 180 degrees relative to the first photovoltaic module 110a such that includes a positive terminal at the second end 114 (now on the “left” side as shown in FIG. 6) and a negative terminal at the first end 112 (now on the “right” side as shown in FIG. 6). In some embodiments, a power electronics unit 150 is electrically connected to the first branch 127 (negative terminal) of the first photovoltaic module 110a and the second branch 129 (positive terminal) of the second photovoltaic module 110b. In some embodiments, the power electronics unit 150 is electrically connected to the first and second photovoltaic modules 110a, 110b in a manner similar to that as described above with respect to the power electronics units 50 to the photovoltaic shingles 10. In some embodiments, the second branch 129 (positive terminal) of the first photovoltaic module 110a is electrically connected to the first branch 127 (negative terminal) of the second photovoltaic module 110b. In some embodiments, the second branch 129 (positive terminal) of the first photovoltaic module 110a is electrically connected to the first branch 127 (negative terminal) of the second photovoltaic module 110b by a jumper wire 136 (electrical jumper cable).

In some embodiments, a lower edge 115 of the photovoltaic module 110b overlays the section 131 of the first photovoltaic module 110a. In some embodiments, the lower edge 115 of the photovoltaic module 110b overlays the at least one bypass diode 130 of the first photovoltaic module 110a to reduce wasted space resulting from the section 131.

In some embodiments, the plurality of photovoltaic modules 110 attached to the backsheet 134 includes two of the photovoltaic modules 110. In some embodiments, the plurality of photovoltaic modules 110 attached to the backsheet 134 includes three of the photovoltaic modules 110. In some embodiments, the plurality of photovoltaic modules 110 attached to the backsheet 134 includes four of the photovoltaic modules 110. In some embodiments, the plurality of photovoltaic modules 110 attached to the backsheet 134 includes five of the photovoltaic modules 110. In some embodiments, the plurality of photovoltaic modules 110 attached to the backsheet 134 includes six of the photovoltaic modules 110. In some embodiments, the plurality of photovoltaic modules 110 attached to the backsheet 134 includes more than six of the photovoltaic modules 110.

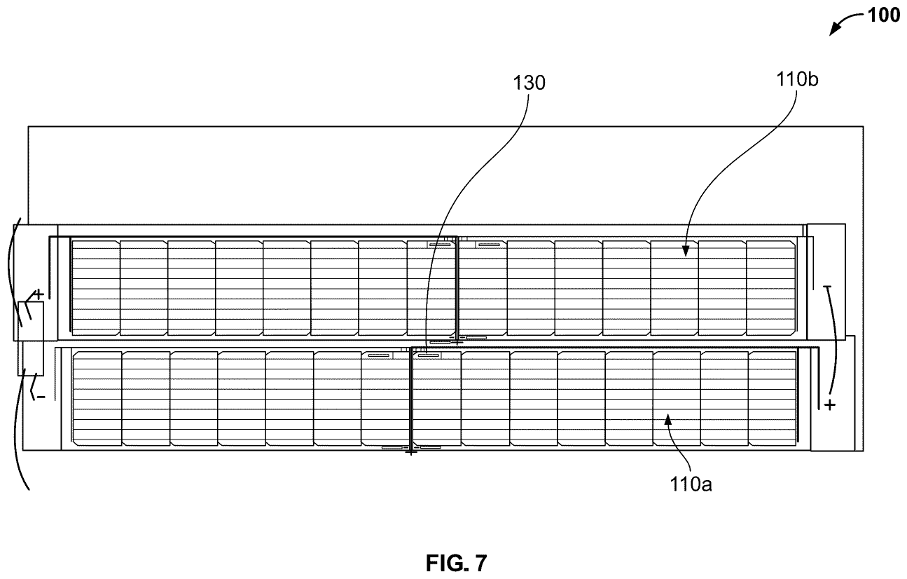

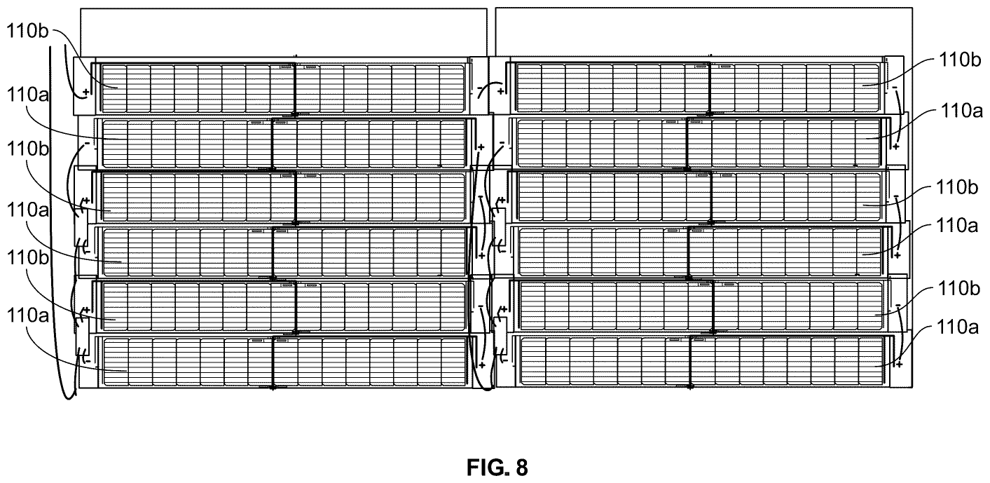

FIG. 7 illustrates the photovoltaic shingle 100 having the photovoltaic module 110b with the string of the solar cells 120 thereof reversed. In some embodiments, the string of solar cells 120 is reversed during lamination of the photovoltaic module 110b. In some embodiments, the first photovoltaic module 110a overlaps the section 131 containing the at least one bypass diode 130. In some embodiments, the first photovoltaic module 110a overlaps the section 131 thereof containing the at least one bypass diode 130 to reduce wasted space. FIG. 8 illustrates a plurality of the photovoltaic modules 110 installed on the roof deck with second photovoltaic module 110b having the reversed strings of solar cells 120.

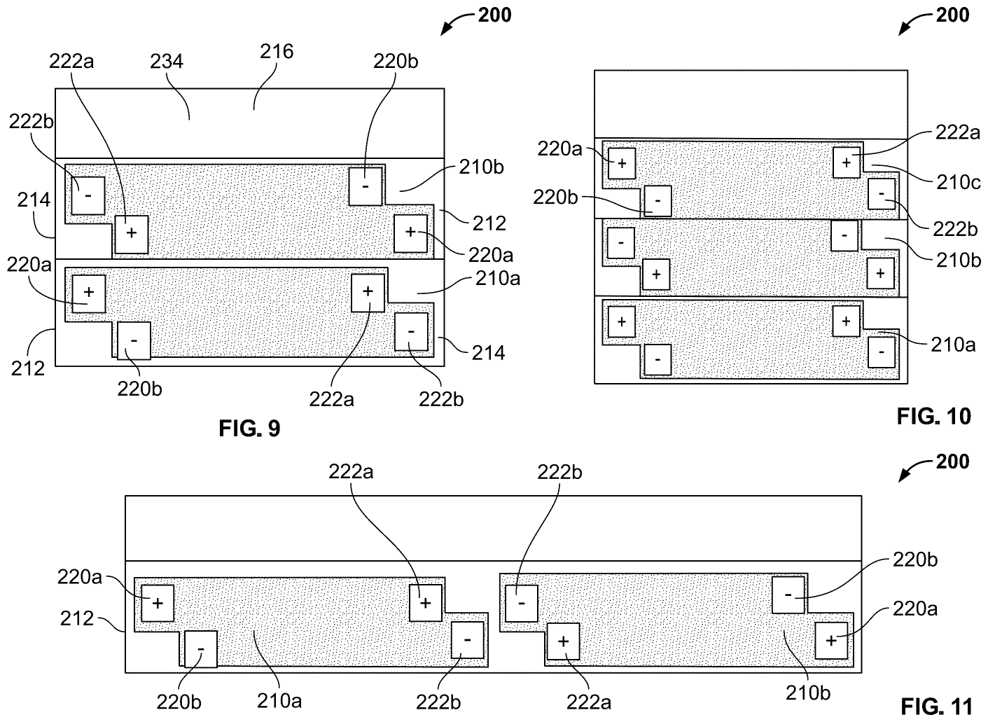

Referring to FIG. 9, in some embodiments, a photovoltaic shingle 200 includes at least two photovoltaic modules 210a, 210b attached to backsheet 234. In some embodiments, the backsheet 234 forms a headlap portion 216. In some embodiments, each of the photovoltaic modules 210a, 210b includes a first end 212, a second end 214 opposite the first end 212, a first positive terminal 220a and a first negative terminal 220b proximate the first end 212, and a second positive terminal 222a and a second negative terminal 222b proximate the second end 214. In some embodiments, the second photovoltaic module 210b is vertically stacked and oriented 180 degrees relative to the first photovoltaic module 210a. Referring to FIG. 10, in some embodiments, the photovoltaic shingle 200 includes a third photovoltaic module 210c attached to a backsheet 234. In some embodiments, the third photovoltaic module 210c is vertically stacked and in the same orientation as the first photovoltaic module 210a. Referring to FIG. 11, in some embodiments, the second photovoltaic module 210b is horizontally positioned adjacent to, and oriented 180 degrees relative to, the first photovoltaic module 210a.

What is claimed is:

1. A system, comprising:
a plurality of building integrated photovoltaic modules installed on a roof deck,
wherein the plurality of building integrated photovoltaic modules is arranged in an array on the roof deck,
wherein the plurality of building integrated photovoltaic modules includes a first building integrated photovoltaic module and a second building integrated photovoltaic module,
wherein the first building integrated photovoltaic module is vertically adjacent to the second building integrated photovoltaic module,
wherein each of the plurality of building integrated photovoltaic modules includes
a plurality of solar cells arranged in at least one row, and
a power electronics unit,
wherein the power electronics unit is adjacent to a first end of one of the at least one row of the plurality of solar cells,
wherein the power electronics unit is electrically connected to the plurality of solar cells, and
wherein the power electronics unit of the first building integrated photovoltaic module is electrically connected to the power electronics unit of the second building integrated photovoltaic module.

2. The system of claim 1, wherein the power electronics unit is horizontally adjacent to the first end of the one of the at least one row of the plurality of solar cells.

3. The system of claim 1, wherein the plurality of building integrated photovoltaic modules is a plurality of solar shingles.

4. The system of claim 1, wherein the at least one row includes a plurality of rows, wherein the plurality of rows includes a first row and a second row above the first row, wherein each of the plurality of building integrated photovoltaic modules includes a first electrical connector proximate to the first end of the first row and electrically connected to the first row of the plurality of solar cells, and a second electrical connector proximate to a first end of the second row and electrically connected to the second row of the plurality of solar cells, and wherein the power electronics unit is connected to the first electrical connector and the second electrical connector.

5. The system of claim 4, wherein the power electronics unit includes a first terminal and a second terminal, wherein the first terminal of the power electronics unit of the first building integrated photovoltaic module is electrically connected to the second electrical connector of the first building integrated photovoltaic module, and wherein the first terminal of the power electronics unit of the second building integrated photovoltaic module is electrically connected to the second electrical connector of the second building integrated photovoltaic module.

6. The system of claim 5, wherein each of the first electrical connector and the second electrical connector includes a first connector and a second connector, wherein the first terminal of the power electronics unit of the first building integrated photovoltaic module is electrically connected to the first connector of the second electrical connector of the first building integrated photovoltaic module, and wherein the first terminal of the power electronics unit of the second building integrated photovoltaic module is electrically connected to the first connector of the second electrical connector of the second building integrated photovoltaic module.

7. The system of claim 6, wherein the power electronics unit of the first building integrated photovoltaic module is mechanically connected to the second electrical connector of the first building integrated photovoltaic module, and wherein the power electronics unit of the second building integrated photovoltaic module is mechanically connected to the second electrical connector of the second building integrated photovoltaic module.

8. The system of claim 7, wherein the first terminal of the power electronics unit of the first building integrated photovoltaic module is mechanically connected to the first connector of the second electrical connector of the first building integrated photovoltaic module.

9. The system of claim 8, wherein the first terminal of the power electronics unit of the second building integrated photovoltaic module is mechanically connected to the first connector of the second electrical connector of the second building integrated photovoltaic module.

10. The system of claim 9, wherein the second terminal of the power electronics unit of the first building integrated photovoltaic module is electrically connected to the second connector of the first electrical connector of the first building integrated photovoltaic module by a first electrical cable.

11. The system of claim 10, wherein the second connector of the second electrical connector of the first building integrated photovoltaic module is electrically connected to the first connector of the first electrical connector of the first building integrated photovoltaic module by a second electrical cable.

12. The system of claim 11, wherein the second terminal of the power electronics unit of the second building integrated photovoltaic module is electrically connected to the second connector of the first electrical connector of the second building integrated photovoltaic module by a third electrical cable.

13. The system of claim 12, wherein the second connector of the second electrical connector of the second building integrated photovoltaic module is electrically connected to the first connector of the first electrical connector of the second building integrated photovoltaic module by a fourth electrical cable.

14. The system of claim 13, wherein the power electronics unit includes a third terminal and a fourth terminal, wherein the third terminal of the power electronics unit of the first building integrated photovoltaic module is electrically connected to the fourth terminal of the power electronics unit of the second building integrated photovoltaic module by a fifth electrical cable.

15. The system of claim 14, further comprising a third electrical connector installed on the roof deck, wherein each of the power electronics unit of the first building integrated photovoltaic module and the power electronics unit of the second building integrated photovoltaic module is electrically connected to the third electrical connector.

16. The system of claim 15, wherein the third electrical connector includes a first connector and a second connector, wherein the third terminal of the power electronics unit of the second building integrated photovoltaic module is electrically connected to the first connector of the third electrical connector by a sixth electrical cable.

17. The system of claim 16, wherein the fourth terminal of the power electronics unit of the first building integrated photovoltaic module is electrically connected to the second connector of the third electrical connector by a seventh electrical cable.

18. The system of claim 1, wherein the power electronics unit includes a housing and power electronics within the housing.

19. The system of claim 18, wherein the power electronics includes an optimizer, a bypass diode, system monitoring electronic components, a rapid shutdown device, an electronic communication component, or combinations thereof.

20. The system of claim 4, wherein each of the plurality of rows includes a second end opposite the first end of the row, wherein each of the first building integrated photovoltaic module and the second building integrated photovoltaic module includes a first negative electrical terminal located at the first end of the first row thereof, a first positive electrical terminal located at the second end of the second row thereof, a second positive electrical terminal located at the first end of the second row thereof, and a second negative terminal located at the second end of the second row thereof.

21. The system of claim 1, wherein the plurality of building integrated photovoltaic modules is installed on the roof deck by a plurality of fasteners.

22. The system of claim 1, wherein the plurality of building integrated photovoltaic modules includes a third building integrated photovoltaic module, wherein the third building integrated photovoltaic module is horizontally adjacent to the first building integrated photovoltaic module.

23. The system of claim 22, wherein the plurality of building integrated photovoltaic modules includes a fourth building integrated photovoltaic module, wherein the fourth building integrated photovoltaic module is horizontally adjacent to the second building integrated photovoltaic module.

24. The system of claim 23, wherein the fourth building integrated photovoltaic module is vertically adjacent to the third building integrated photovoltaic module.

25. The system of claim 24, wherein the power electronics unit of the third building integrated photovoltaic module is electrically connected to the power electronics unit of the fourth building integrated photovoltaic module.

26. A system, comprising:
a plurality of building integrated photovoltaic modules installed on a roof deck,
wherein the plurality of building integrated photovoltaic modules is arranged in an array on the roof deck,
wherein the plurality of building integrated photovoltaic modules includes a first building integrated photovoltaic module and a second building integrated photovoltaic module,
wherein the first building integrated photovoltaic module is vertically adjacent to the second building integrated photovoltaic module,
wherein each of the plurality of building integrated photovoltaic modules includes a plurality of solar cells arranged in at least one row;
a first power electronics unit,
wherein the first power electronics unit is adjacent to a first end of one of the at least one row of the plurality of solar cells of the first building integrated photovoltaic module,
wherein the first power electronics unit is electrically connected to the plurality of solar cells of the first building integrated photovoltaic module; and
a second power electronics unit,
wherein the second power electronics unit is adjacent to a first end of one of the at least one row of the plurality of solar cells of the second building integrated photovoltaic module, and
wherein the first power electronics unit is electrically connected to the second power electronics unit.

27. A method, comprising:
obtaining a plurality of building integrated photovoltaic modules,
wherein each of the plurality of building integrated photovoltaic modules includes
a plurality of solar cells arranged in at least one row, and
a power electronics unit,
wherein the power electronics unit is adjacent to a first end of one of the at least one row of the plurality of solar cells,
wherein the power electronics unit is electrically connected to the plurality of solar cells; and
installing at least a first building integrated photovoltaic module and a second building integrated photovoltaic module on a roof deck,
wherein the first building integrated photovoltaic module is vertically adjacent to the second building integrated photovoltaic module, and
wherein the power electronics unit of the first building integrated photovoltaic module is electrically connected to the power electronics unit of the second building integrated photovoltaic module.

28. The method of claim 27, further comprising installing a third building integrated photovoltaic module and a fourth building integrated photovoltaic module on the roof deck, wherein the third building integrated photovoltaic module is horizontally adjacent to the first building integrated photovoltaic module, and wherein the fourth building integrated photovoltaic module is horizontally adjacent to the second building integrated photovoltaic module and vertically adjacent to the third building integrated photovoltaic module.

29. The method of claim 27, wherein the plurality of building integrated photovoltaic modules is a plurality of solar shingles.

30. The method of claim 27, wherein the plurality of building integrated photovoltaic modules is installed on the roof deck by a plurality of fasteners.
